(19) United States
(12) Patent Application Publication
(10) Pub. No.: US 2007/0029047 A1
(43) Pub. Date: Feb. 8, 2007

(54) Thermal Bond Tape Feeding Attachment

(76) Inventor: Jesse Stewart Harrah SR., Conway, SC (US)

Correspondence Address: JESSE S. HARRAH, 2600 TWO PINE ROAD, CONWAY, SC, 29526, US

(21) Appl. No.: 11/161,508

(22) Filed: Aug. 5, 2005

(51) Int. Cl. B32B 37/00

(52) U.S. Cl. 156/499; 156/543

(57) ABSTRACT

Disclosed is an attachment or thermal bond tape guide to be used in conjunction with a portable automatic hot air welder. The apparatus consists of a mechanical appliance for the purpose of introducing thermal bond tape between the lap joint of various fabrics. These fabrics will not weld without introducing a bonding agent like thermal bond adhesive tape. An example of such fabric would be acrylic. The mechanism has a circular tube for holding tape and a series of slots and guides so the tape feeds the welded joint, traveling with the machine as it progresses along the lap joint. Thus, enabling the portable automatic hot-air welder to join acrylic or canvas fabrics.

### BACKGROUND OF INVENTION

1. Field of Invention

As an awning fabricator, it is known to me, the growing need to heat-seal or weld acrylic fabrics, lightweight canvas, or architectural fabrics. The process of utilizing thermal bond adhesive tape with a portable hot air welder, to my knowledge, has not been used. Sinclair, U.S. Pat. No. 5,865,942, discusses the many benefits of a wedge welder, he does not mention welding acrylics. However, it is known to the industry that his machine will weld acrylics utilizing a hot wedge & thermal bond adhesive tape. It was my desire to create the same weld using an existing portable hot air welder. This created the need for an attachment to feed the adhesive or bonding tape to the weld area.

Therefore, the present invention relates to an attachment for a portable hot air welder to allow for thermal bond tape to be introduced to the weld. This will enable the welder to make welds on acrylic fabrics utilizing their existing portable hot air welder. Also, the consumer will have a choice of welders & techniques for welding acrylics.

2. Description of Related Art

An apparatus for welding or heat-sealing of thermo plastics or vinyl sheets is nothing new, but to join together acrylics or canvas is just coming about. U.S. Pat. No. 6,213,184, issued to Sinclair, boasts many types of welds. However, not all companies have a need for multiple welds. Also mentioned is the skill involved in producing consistent welds with Chitjion U.S. Pat. No. 4,855,004 hot air welder. This issue has been resolved with the new design of U.S. Pat. No. 6,866,077 Zurmuhle. The Zurmuhle welder boasts positive tracking with higher welding speeds. In discussing pros & cons of welders, the noise & nominal cost of a lightweight hot air welder like the Chitjian welder or the Zurmuhle welder might out weigh the weight & expense of a multi-task wedge welder. It was my intention to invent an apparatus to make peoples' existing hot air welders, capable of welding a sufficient lap joint on acrylic or canvas, the same as it does on vinyl.

### SUMMARY OF INVENTION

To solve the problem that exists with existing portable hot air welders not being capable of welding acrylics & canvas. The portable hot air welders have always been reliable & produce aesthetically pleasing welds, which are very durable & are time tested. With the present invention we can continue to use these welders and get a 25% stronger seam than sewing of the architectural fabrics. My staff and I are presently using the present invention to produce quality covers for awnings, boats, curtains, and etcetera.

### BRIEF DESCRIPTION OF THE DRAWINGS

The forgoing aspects and many of the attendant advantages of this invention will become more readily appreciated as the same becomes better understood by reference to the following detailed description, when taken in conjunction with the accompanying drawings, wherein:

FIG. 1 is a side view perspective showing the tape attachment installed to an existing welder.

FIG. 2 is a rear view perspective showing the connection to an existing welder.

FIG. 3 shows a side view perspective of the apparatus.

FIG. 4 is a top view perspective of the apparatus.

### DESCRIPTION OF THE PREFERRED EMBODIMENTS

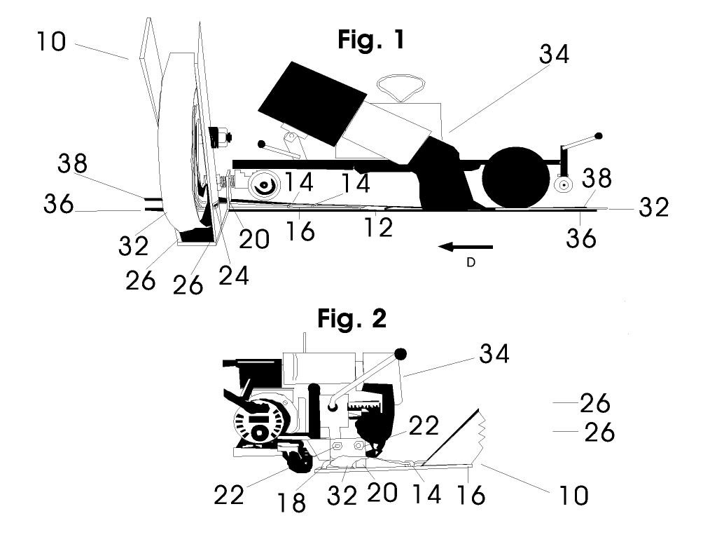

FIG. 1 portrays a typical, portable, automatic hot air welder 34 of which consist in brief: drive wheel, heat device, blower and motor for movement. As pertinent to the present invention, however, the hot air welder is used to join together two pieces of thermo plastic material. This machine is not presently capable of welding acrylic fabrics.

In accordance with the present invention, a tape attachment 10 is attached to the hot air welder 34 to allow for the feeding of thermal bond tape 32. This will now enable the operator to have the ability to weld acrylic fabrics. FIG. 1 shows a side view of the hot air welder 34 with the attachment 10 located on the left side of the hot air welder. FIG. 1 also shows the basic procedure of setup with a bottom sheet of acrylic 36 and a top sheet of acrylic 38 with the thermal bond tape 32 between the latter two sheets. FIG. 2 shows a cutaway section of the present invention 10 mounted to the rear of a hot air welder by the means of two 5/16″ cap screws 22. This allows for a rigid connection of the bottom plate 16 to the welder.

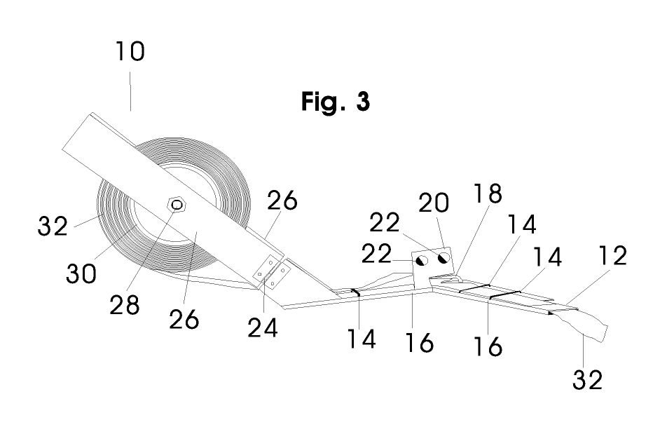

Drawing 2 shows the present invention in its entirety. The tape attachment portrayed in drawing 2 FIG. 3 shows a side view which consists of a bottom plate 16, tape rails 26 and mounting plate 20. The apparatus is constructed of 1″×⅛″ aluminum plate welded together. Mounting plate 20 includes a slot for allowing the tape to pass by with out being obstructed. The two tape rails 26 supports a 3″×1″ aluminum drum 30, which the thermal bond tape 32 rides on. Hinge 24 is used to facilitate the changing of the consumable tape; also a ¼″×2″ bolt and nut 28 are used to secure the tape after changing.

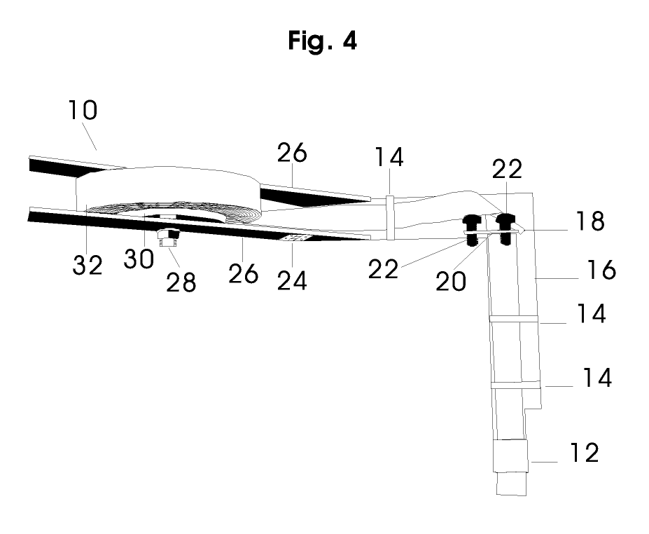

The tape attachment in FIG. 3 also shows a series of tape guides: the bottom plate 16 has three bottom plate guides 14. Directional guide 18 is used to transfer the direction of the tape. This enables for a more preferred mounting of the present invention. Front guide 12 enables the tape to be in a more constricted position as it enters the weld area. This allows for more precise tracking of the tape. The construction of the guide system is most visible in FIG. 4, which shows a top view of the present invention.

What is claimed is:

1. Attachment or apparatus for welding acrylic or light weight canvas in which an apparatus (FIG. 4) is to be connected to existing portable automatic hot air welder.

2. Means and method of transferring the thermal bond tape from tape attachment to the weld area.

3. The attachment in claim 2, in which the tape is held by a 3′″ circumference tube.

4. The 3″ circumference tube in claim 3, in which it is attached to two 1″×⅛″ flat plates to support the tube and also acts as a stop to keep the tape from falling loose.

5. The attachment in claim 4, in which one of the 1″×⅛″ plates is hinged on one side to facilitate changing the consumable tape. The hinged portion of said plate is held in closed position by a ¼′″×2″ bolt welded on the backside and a ¼″ wing nut on the front.

6. The attachment in claim 2, in which the said attachment can be fastened to the portable welder at any one of a plurality of ways.

7. The attachment in claim 6, where as said attachments would mount to existing portable hot air welders.

8. The attachment in claim 2, in which all slots and guides for routing tape are claimed.

9. The attachment in claim 8 (FIG. 4), in which said guide has a 90-degree turn along its horizontal plane.
